(19) United States
(12) Patent Application Publication
(10) Pub. No.: US 2026/0130358 A1
(43) Pub. Date: May 14, 2026

(54) BIRD DEFLECTOR AERIAL DEPLOYMENT DEVICE AND METHOD

(71) Applicant: KRONOS AERIAL PHOTOGRAPHY LTD, Kiryat Aryeh (IL)

(72) Inventors: Machluf Eliyahu MALKA, Tel-Aviv (IL); Gil NACHMANY, Binyamina (IL)

(21) Appl. No.: 19/120,050

(22) PCT Filed: Jan. 8, 2024
(86) PCT No.: PCT/IL2024/050022

§ 371 Date: Apr. 10, 2025

(30) Foreign Application Priority Data
Jan. 8, 2023 (IL) 299742

(51) Int. Cl. A01M 29/00; H02G 1/02; H02G 7/00

(52) U.S. Cl. CPC A01M 29/00; H02G 1/02; H02G 7/00

(57) ABSTRACT

The present invention provides a deployment method and a corresponding device suitable for mounting devices such as bird-repellent, and IoT devices of different designs onto a wire, such as an electric wire.

### FIELD OF THE INVENTION

The present invention relates to the technical field of overhead cable ancillaries'installation. In particular, the present invention relates to a device for aerial deployment of cable-anchored bird deflectors along overhead cables such as for deterring incoming low-flight birds from electric cable.

### BACKGROUND OF THE INVENTION

Wires and cables, such as electric power cables, constitute a major threat to low-flying birds. Due to the limitations of vision and their inconspicuous nature, wires are essentially invisible to birds, which may lead to disastrous results.

Electric power is an essential requirement for humankind and the availability of electricity has become a part of the standard of living. The transport of electricity from power plants to users is mainly via aboveground powerlines. However, electric power cables and wires constitute a major threat to birds that tend to rest on them or fly into them, which may lead to fatal injuries and death of birds.

In such wires and cables, some devices are placed thereon to increase their visibility and to divert incoming birds to prevent collisions and mitigate the environmental problem of bird mortality. Normally, these devices are commercially known as bird-or flight-diverters.

Various bird-deflector devices and deflecting methods were developed to reduce the problem of birds resting on electric wires as well as of birds flying into the wires. However, all known devices and methods provide only limited success and have their disadvantages.

One well known warning device is a spherical marker for highlighting high-voltage lines, as described in U.S. Pat. Nos. 4,885,835, 5,964,180, 5,372,335, and 5,224,440, which are widely used to alert nearby aircrafts. These are large sized spheres that are placed on the cables. Unfortunately, these spheres do not present effective bird-repelling properties, especially since they are static and thus birds do not necessarily identify the presence of the wire in between such spheres. In addition, these spheres are large sized, difficult to install, and expensive.

U.S. Pat. No. 5,058,335 teaches the attachment of plastic flexible fingers onto wires, which deter birds from landing thereon by providing an unstable landing site. The fingers are also visibly flexed by wind, vibrations, or movement of the protected wire, and thus also deter birds from landing on the wire. Unfortunately, these fingers are effective only for a short distance, namely close to their anchoring point, which requires assembling these fingers in near proximity to one another, which is costly, adds weight to the wires, and time consuming.

U.S. Pat. No. 5,425,328 provides another flight diverter comprised of two polymeric slats, whose movement facilitates visualization by birds. However, its fixation system to the cable has metallic components that are prone to corrosion which reduces the lifetime thereof.

U.S. Pat. No. 4,962,619 describes wind-operated flaps to deter birds from landing or approaching a protected area (e.g., an electric wire)-even when spaced apart. The problem with these flaps is their connection to the wire that is done manually by crimping, which loosens over time. US 2004/0255837 tried to improve the design of these flaps by providing a connector having a rotatable ratcheted gripping mechanism, which allegedly improves the attachment of the flap to the wire. However, this mechanism is cumbersome and requires a relatively long installation time, which makes the overall assembly process complicated and long.

Notably, in areas where electric wires are low enough and ground access is practical, ground-based installation platforms can be used to mount such bird repellent devices on the wires, such as ladders, lifts, cranes, cherry pickers, etc. However, ground-based installation is often impractical or impossible due to the height, geographical remoteness, or the underlying surface (lakes, rivers, rough terrain, etc.) underneath the wires, which makes it hard to follow through the wire path for installing such aerial warning devices along the entire length of the wire.

One limited solution for installation of bird repellent device involves a climbing or crawling robot that is attached to a segment of the suspended cable and provides a remote-controlled installation platform. This robot is effective and safe, but requires manual attachment and detachment to the cable, is cumbersome and pricy, time consuming, impractical for many installations, and cannot overcome obstacles on the wires (such as support poles).

Another solution, used today, is the use of helicopters as an installation platform, in which the helicopter hovers close to the electric wire with a lineman sitting outside the helicopter on a platform, and connects (or removes) aerial markers on the electric wires/cable. However, this method possesses a great risk to both the pilot and the lineman and requires highly trained and exceptional personal in order to avoid damage and harm. In addition, the operating and insurance costs are high.

Accordingly, a need exists for a simple, cost effective and safe way to install bird repellent devices of different types and designs on cables, such as electric wires/cables. The present invention provides such a method as well as an apparatus for mounting and securing various bird repellent devices having different wire-attachment mechanisms, to wires.

### SUMMARY OF THE INVENTION

In one aspect, the invention relates to a multipurpose deployment device (100) for deploying bird-repellent or IoT (Internet of Things) devices with different types of wire-attachment mechanisms onto a wire, the device (100) comprises: a) one or more interchangeable fixture housings (110, 120), each of which is adapted to hold and facilitate the deployment of a different type of wire-attachment mechanism, integrated with a bird-repellents or an IoT device, wherein each of the one or more interchangeable fixture housings (110, 120) comprises one or more unique leading-rod (111,121), and b) an optionally insulated and rigid/extendible extension connector (102) configured to connect with a carrying unmanned aerial vehicle (UAV), wherein extension connector (102) is adapted with universal support (102a) configured to receive one or more units of said one or more interchangeable fixture housings (110, 120), and thus, one or more wire-attachment mechanisms of different types, thereby facilitating the deployment of one or more units of the bird-repellent or IoT devices, by a single UAV, and wherein device (100) further comprises one or more sensors that indicate as to the engagement of said device with a wire.

In an embodiment, the multipurpose deployment device (100) according to any of the above embodiments, further comprises an image-capturing device (103).

The device may comprise a first and a second interchangeable fixture housings (110, 120), wherein each one of said first and second interchangeable fixture housings (110, 120) comprises a unique leading-rod (111, 121) and is designed to carry and deploy a bird-repellent or IoT device having a different wire-attachment mechanism. It should be noted that interchangeable fixture housings (110, 120) according to any of the embodiments above, may be integrated with similar or with different bird-repellents/IoT devices. It should be further noted that in either of the above embodiments and examples of device (100), the latter may or may not comprise an image-capturing device, and/or Global Positioning System (GPS).

In another aspect, a method for deploying bird-repellent or IoT (Internet of Things) devices with different types of wire-attachment mechanisms onto a wire is disclosed, the method comprising the steps of: a) providing a multipurpose deployment device (100) according to any of the above embodiments and examples and connecting the same by an extension connector (102) to an unmanned aerial vehicle (UAV), b) attaching one or more wire-attachment mechanisms of different types, integrated with bird-repellent or IoT device(s), to one or more adequate interchangeable fixture housings (110, 120), and attaching the same to universal support (102a) of said extension connector (102), c) approaching a target deployment position along a wire with said UAV until a leading-rods (111, 121), of an interchangeable fixture housing (110, 120) associated with a desired unit of the various bird-repellent or IoT devices, contacts said wire, and keep approaching the wire while said one or more unique leading-rods (111, 121) guide the wire towards the corresponding wire-attachment mechanism carried on the associated interchangeable fixture housing (110, 120), d) interlocking the wire-attachment mechanism onto the wire thereby attaching said desired unit of the various bird-repellent or IoT devices onto the wire, e) repeating steps (c) and (d) until all bird-repellent or IoT devices of step (b) are deployed at their target deployment positions along the wire, f) distancing the UAV from said wire; and repeating steps (b) through (f) as needed until all required bird-repellent or IoT devices are mounted and secured on the wire.

### BRIEF DESCRIPTION OF THE DRAWINGS

For a better understanding of various embodiments of the present invention and to show how the same may be carried into effect, reference is made, by way of example, to the accompanying illustrative drawings, in which:

FIGS. 1A and 1B illustrate known bird deflectors anchored on electric wires such as: (A) BirdMark Flapper (P&R Tech), and (B) Firefly Flapper (P&R Tech);

FIG. 2A illustrates one possible configuration of a multipurpose deployment device, according to an embodiment of the invention;

FIG. 2B illustrates alternate configuration of a multipurpose deployment device, according to an embodiment of the invention;

FIG. 3 illustrates an interchangeable fixture housing and the interlocking of a wire-attachment mechanism carried thereby onto an overhead wire, according to an embodiment of the invention;

FIGS. 4A-4D illustrate another interchangeable fixture housing and the interlocking of a wire-attachment mechanism carried thereby onto an overhead wire, according to an embodiment of the invention;

FIG. 5 illustrates an exemplary configuration of a UAV that carries a deployment device, according to an embodiment of the invention; and

FIGS. 6A-6B are illustrations of a deployment device of the invention having a single interchangeable fixture housing; each figure illustrates a different interchangeable fixture housing according to an embodiment of the invention.

In the above drawings, structural details of the invention are shown to provide a fundamental understanding of the invention, where the following detailed description, taken with the drawings, makes apparent to those skilled in the art how several forms of the invention may be embodied in practice.

### DETAILED DESCRIPTION OF THE INVENTION

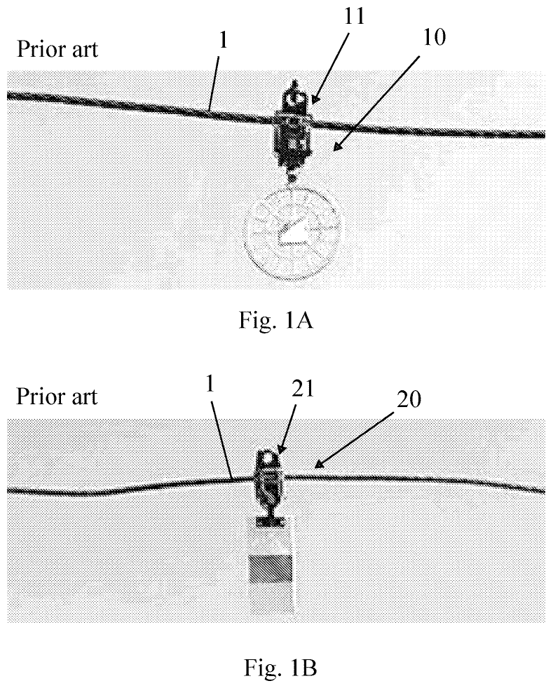

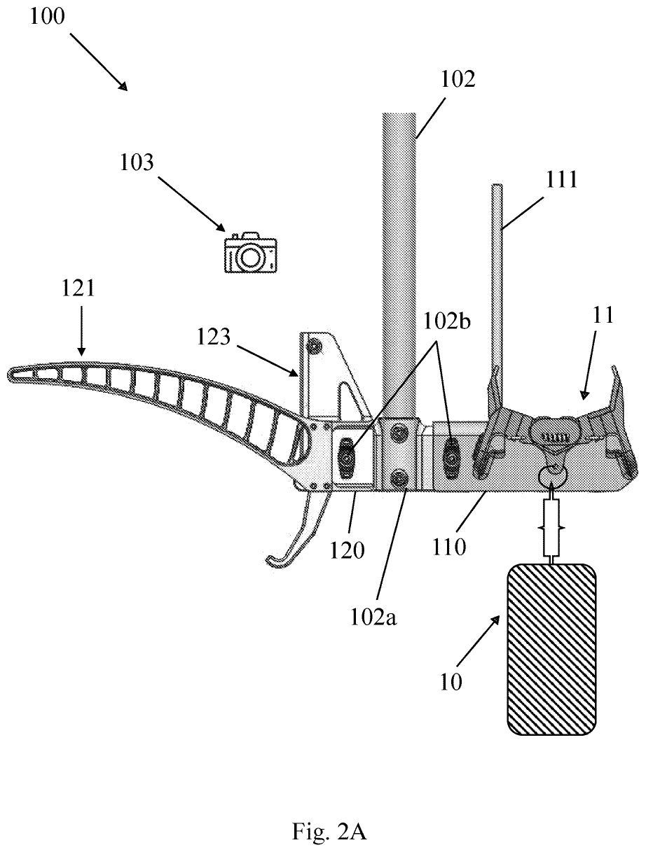

Two main types of bird-repellents are commonly deployed along electric wires/cables: OWL Diverter by PLP, and FireFly & Birdmark by Hammarprodukter (illustrated in FIGS. 1A-1B). All are designed to repel birds off electric wires. The main difference between those bird repellents is their wire-attachment mechanisms and, correspondingly, their deployment process along the cables. In either case, manual anchoring of the bird-repellent devices to the electric wire is required, which means that an individual needs to work in a high and dangerous environment. Moreover, the fact that each bird-repellent uses a different wire-attachment mechanism and thus requires a different deployment method means that any automated device developed to deploy one bird-repellent is not suitable for deploying other bird-repellent.

The terms “wire” and “cable”, as used herein, refer to, e.g., any overhead wires/cables, their support structures, power lines, electrical transmission wires, telephone wires, fiber optic cables, suspension cables on bridges, aerial trams and ski-lifts, guy-wires supporting towers, and the like.

The terms “bird-deflector”, “bird-repellent”, “bird-warning device”, “bird-repellent device”, and “flight-diverter” as used herein interchangeably, refer to devices that intend to scare, deter or repel birds and thereby prevent their flying into a wire, like an electric wire, or landing thereon.

The present invention provides a uniquely designed multipurpose deployment device that is suitable for deploying various types of bird-repellents with different wire-attachment mechanisms using a single deployment device and in a single deployment iteration. In certain embodiments, where the proposed deployment device is airborne, e.g., carried by a hovering aircraft, such as a drone/Unmanned Air Vehicle (UAV), it facilitates the deployment of different bird-repellents on a single flight.

Accordingly, in the first aspect, the present invention provides a deployment device that can be used with different wire-attachment mechanisms of various bird-repellent devices or IoT (Internet of Things) devices to anchor those bird-repellent or IoT devices onto an overhead wire.

The term “IoT” as used herein refers to any device that is either self-powered or that draws power from the electric wire it is attached to, the device is designed to obtain data using various sensors and other means about different parameters of the power grid of which the power line is part of, and subsequently communicate, e.g., wirelessly, with a remote computing management system that is designed receive and collect data from said IoT device regarding the power grid's status.

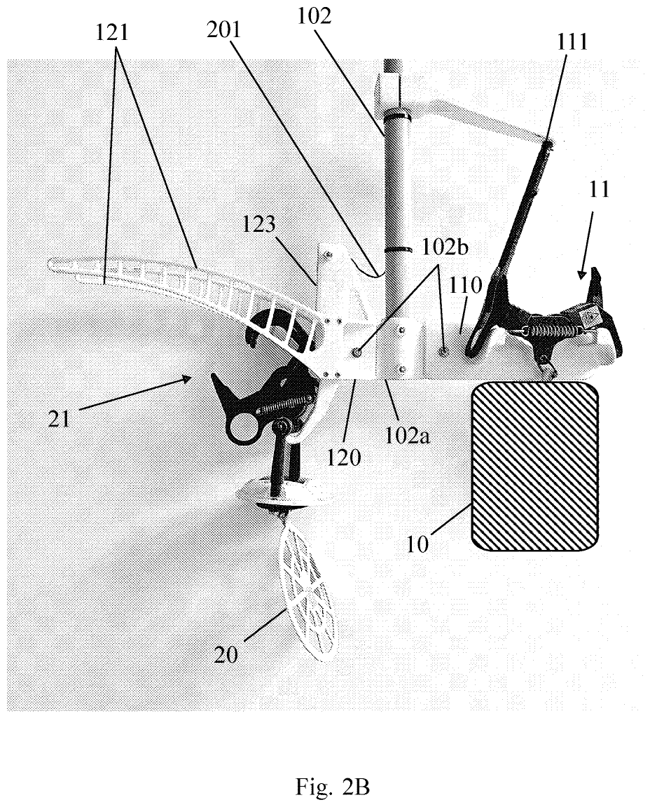

In certain embodiments, the multipurpose deployment device (100) is a double-sided fixture housing having a different fixture housing on each side thereof, such as device (100) of FIGS. 2A-2B. In certain embodiments, the multipurpose deployment device (100) comprises 2, 3, 4, 5 or more different interchangeable fixture housings spaced apart from one another, such that each fixture housing is suitable for a different bird-repellent or IoT device with its unique wire-attachment mechanism.

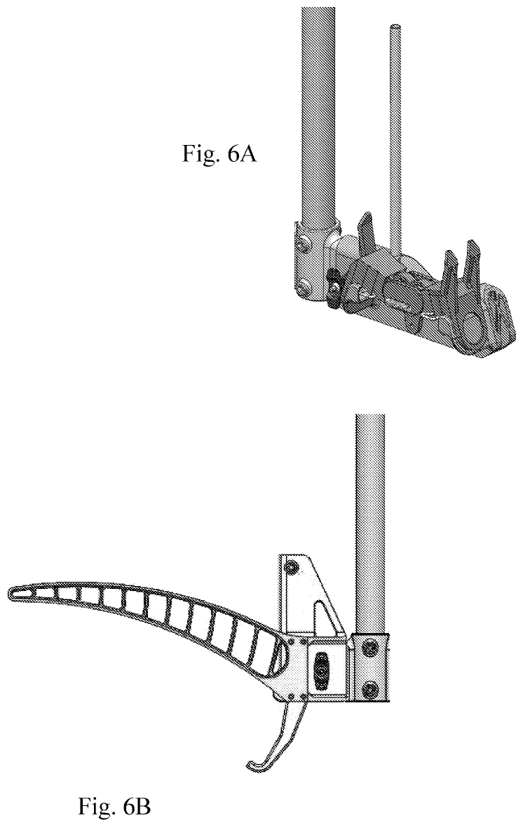

In specific embodiments, the proposed deployment device may comprise a single fixture housing (see illustrated in FIGS. 6A & 6B) for a specific wire-attachment mechanism and a leading-rod. In alternative specific embodiments, the deployment device is a multipurpose deployment device (100) that can be used with different wire-attachment mechanisms of various bird-repellent devices or IoT devices.

In certain embodiments, the multipurpose deployment device (100) according to any of the embodiments above comprises at least a first and a second interchangeable fixture housings (110, 120) for two different bird-repellent or IoT devices with different wire-attachment mechanisms, wherein each one of said first and second interchangeable fixture housings (110,120): (i) is designed to fit a different bird-repellent or IoT device with its unique wire-attachment mechanism (i.e., the bird-repellent or IoT device's fixture to the power line); and (ii) comprises its own leading-rod (111, 121). In specific embodiments, the leading-rod (111, 121) is designed to guide the relevant fixture housing towards the electric wire. In further or alternative specific embodiments, the leading-rod (111, 121) is electrically insulated.

In certain embodiments, the deployment device according to any of the embodiments above further comprises: (i) an extension connector (102) for connecting said device (100) to an unmanned aerial vehicle (UAV), where the extension connector (102) may comprise insulation component or may be fabricated from an insulating material, for protecting a carrier of device (100) from the undesired transmission of electric current; and/or (ii) an image-capturing device such as a camera (103) designed to identify the electric wire and assist in the process of anchoring the bird-repellent or IoT device to an overhead wire. In specific embodiments, the extension connector (102) is a fixed rigid pole. In alternative specific embodiments, the extension connector (102) is extendable, e.g., hydraulic or mechanic, thus enabling modifying the distance between the UAV and the bird-repellent or IoT device, e.g., for installing in hard-to-reach places or when there are obstacles.

In certain embodiments, the extension connector (102) is a standard robotic arm, having a length sufficiently long to access the wire without the UAV touching nearby wires or poles. In certain embodiments, the extension connector (102) is designed to be connected to the UAV from its top, bottom, or side.

In certain embodiments, the present invention provides a deployment device comprising: (a) a single fixture housing for a specific wire-attachment mechanism; (b) an extension connector for connecting said device to an unmanned aerial vehicle (UAV); and (c) an image-capturing device, such as camera, wherein said fixture housing comprises a leading-rod. FIGS. 6A & 6B illustrate two different deployment devices, each with a different fixture housing that is suitable to deploy a different wire-attachment mechanism.

In certain embodiments, the present invention provides a multipurpose deployment device (100) comprising: (a) a first fixture housing (110) for one wire-attachment mechanism (10); (b) a second fixture housing (120) for a different wire-attachment mechanism; (c) an extension connector (102) for connecting said device (100) to an unmanned aerial vehicle (UAV); and (d) an image-capturing device, such as a camera (103), wherein each one of said first and second interchangeable fixture housings (110,120) comprises its own leading-rod (111, 121), and is designed for the deployment of a different bird-repellent or IoT device.

The terms “drone” and “UAV”, as used herein interchangeably, refer to an Unmanned Aircraft Vehicle, in any shape and size as needed and defined herein. The UAV can be equipped with deployment device (100) for deploying various bird-repellents or IoT devices and may have any number of propellors. The UAV can be operated manually or may be completely autonomous, in which case it comprises or is associated with a computing system that controls its operation.

In a second aspect, the present invention provides an unmanned aerial vehicle (UAV) equipped with deployment device (100) according to any of the embodiments above.

In specific embodiments, the deployment device is a multipurpose deployment device (100) according to any of the embodiments above.

In certain embodiments, the UAV according to any of the embodiments above further comprises: (i) an image-capturing device, such as a camera designed to assist in positioning the UAV and bird-repellent or IoT device in close proximity to the electric wire for anchoring the bird-repellent or IoT device to the electric wire; and/or (ii) a positioning system, e.g., GPS, LPS, ultra-wide-band or visual positioning system (such as a navigation camera), designed to assist in the navigation and positioning of the UAV to a desired location for installing a bird-repellent or IoT device at a desired distance from a previous bird-repellent or IoT device or a pole. In specific embodiments, said positioning system enables the position of the UAV at an exact distance from a previously mounted bird-repellent or IoT device, such that the distances between two adjacent bird-repellent or IoT devices along a wire is essentially identical along the entire wire.

In certain embodiments, the UAV according to any of the embodiments above, is further equipped with an anti-collision system, which prevents unintentional collision thereof with trees, people, other drones, poles (such as electric poles), and wires (such as electric wires), and thereby enables safe navigation of the UAV in complex environments. This anti-collision system includes, but is not limited to, IR range opto-coupler, ultrasonic range measurement, stereoscopic camera, RADAR and vision camera.

In certain embodiments of the UAV according to any of the embodiments above, the UAV's power source is a rechargeable power source. In specific embodiments, the power source is replaceable, such that it can be easily replaced within seconds to allow continuous working by the UAV without the need for long recharging time. In alternative or additional embodiments, the power source is photovoltaic, such that it can provide constant power to the UAV during the daytime.

In certain embodiments, the UAV, according to any of the embodiments herein, comprises or is wirelessly associated with a computing system that enables the UAV to be completely independent/autonomous so that there is no need for manual control.

In a third aspect, the present invention provides a method for mounting and securing multiple bird-repellent devices and/or IoT (internet of things) devices onto a wire, by using the deployment device according to any of the embodiments above or by using a UAV equipped with such a device.

In a specific embodiment, the above method comprises the steps of: (a) attaching the deployment device according to any of the embodiments above having a single fixture housing to an unmanned aerial vehicle (UAV) or providing a UAV accordingly equipped with such a deployment device; (b) attaching a desired bird-repellent or IoT device with an integrated wire-attachment mechanism to the fixture housing within said deployment device; (c) positioning said UAV near said wire until said leading-rod touches said wire; (d) interlocking said wire-attachment mechanism onto said wire thereby securing said bird-repellent or IoT device onto the wire; (e) distancing said UAV from said wire; (f) reloading said deployment device with a desired bird-repellent or IoT device; and (g) repeating steps (a) through (f) as needed until attaching all required bird-repellent or IoT devices are mounted and secured on the wire.

In alternative specific embodiment, the above method comprises the steps of: (a) attaching the multipurpose deployment device (100) according to any of the embodiments above to an unmanned aerial vehicle (UAV) or providing a UAV equipped with such a device (100), such as the UAV according to any of the embodiments above; (b) attaching a desired bird-repellent or IoT device with an integrated wire-attachment mechanism to an adequate fixture housing (110, 120) within said multipurpose deployment device (100); (c) positioning said UAV near said wire until said leading-rod touches said wire; (d) interlocking said wire-attachment mechanism onto said wire thereby securing said bird-repellent or IoT device onto the wire; (e) distancing said UAV from said wire; (f) reloading said multipurpose deployment device (100) with a desired bird-repellent or IoT device; and (g) repeating steps (a) through (f) as needed until attaching all required bird-repellent or IoT devices are mounted and secured on said wire.

In specific embodiments, the above method is for mounting and securing multiple bird-repellent devices onto a wire, the method comprising the steps of: (a) attaching the multipurpose deployment device (100) according to any of the embodiments above to an unmanned aerial vehicle (UAV) or providing a UAV equipped with such a device (100), such as the UAV according to any of the embodiments above; (b) attaching a desired bird-repellent device with an integrated wire-attachment mechanism to an adequate fixture housing (110, 120) within said multipurpose deployment device (100); (c) positioning said UAV near said wire until said leading-rod touches said wire; (d) interlocking said wire-attachment mechanism onto said wire thereby securing said bird-repellent device onto the wire; (e) distancing said UAV from said wire; (f) reloading said multipurpose deployment device (100) with a desired bird-repellent device; and (g) repeating steps (a) through (f) as needed until attaching all required bird-repellent devices are mounted and secured on said wire. In a specific embodiment of the above method, the wire is an electric wire/cable.

In alternative specific embodiments, the above method is for mounting and securing multiple IoT devices onto an electric wire, the method comprising the steps of: (a) attaching the multipurpose deployment device (100) according to any of the embodiments above to an unmanned aerial vehicle (UAV) or providing a UAV equipped with such a device (100), such as the UAV according to any of the embodiments above; (b) attaching a desired IoT device with an integrated wire-attachment mechanism to an adequate fixture housing (110, 120) within said multipurpose deployment device (100); (c) positioning said UAV near said wire until said leading-rod touches said electric wire; (d) interlocking said wire-attachment mechanism onto said wire thereby securing said IoT device onto the wire; (e) distancing said UAV from said wire; (f) reloading said multipurpose deployment device (100) with a desired IoT device; and (g) repeating steps (a) through (f) as needed until attaching all required IoT devices are mounted and secured on said wire.

In certain embodiments, the method according to any of the embodiments above, step (b) of attaching a desired bird-repellent or IoT device to the adequate fixture housing (110,120), and step (f) of reloading said multipurpose deployment device (100) with a desired bird-repellent or IoT device, is carried out manually or automatically using a dedicated dispenser.

In certain embodiments of any of the methods according to any of the embodiments above, step (c) of positioning said UAV near said wire is carried out using a positioning system that determines the position and distance of the UAV relative to a previous mounted bird-repellent device.

In certain embodiments, the method according to any of the embodiments above, step (d) of interlocking said wire-attachment mechanism onto said wire is carried out: (i) automatically due to the pressing of the wire-attachment mechanism against said wire; or (ii) by activation of an actuator (123) and/or via an electrical activation of said wire-attachment mechanism.

FIGS. 1A-1B illustrate currently used bird-repellents attached on an overhead wire: In FIG. 1A a first bird-repellent (10) (e.g., BirdMark Flapper (P&R Tech)) is attached by a first wire-attachment device (11) on a wire (1); and in FIG. 1B a second bird-repellent (20) (e.g., Firefly Flapper (P&R Tech)) is attached by a second wire-attachment device (21) on a wire (1). As can be seen, each device is mounted on wire (1) with a different wire-attachment mechanism (11,21). Accordingly, for the deployment of these two bird-repellents (10,20) to the wire (1), one must use two separate instruments or anchoring methods.

In the following detailed description, non-limiting embodiments of the present invention are discussed and illustrated, where references are made to accompanying drawings. These embodiments and accompanying drawings should be understood as non-limiting examples of implementing the present invention. Furthermore, terms such as “optionally”, “for instance”, “for example”, “exemplary”, “e.g.,”, “may”, etc., refer to optional features being selected in certain embodiments of the invention for the sake of simplicity and clarity of explanation. It should be understood, however, that optional features mentioned in different embodiments may be used, in conjunction and/or separately, to implement further embodiments of the present invention.

FIG. 2A is an illustration of one possible configuration of a multipurpose deployment device (100), according to an embodiment of the invention, that is suitable for deploying two types of bird-repellents (a single bird-repellent (10) is shown in FIG. 2A), each of which is adapted with a different wire-attachment mechanism (e.g., wire-attachment mechanism (11) of bird-repellent (10)). Device (100) comprises an extension connector (102) for connecting the device (100) to an unmanned aerial vehicle (UAV). The connector (102) may be electrically to prevent unintentional electrical damage to the UAV while working on a live powerline.

Two (or more) interchangeable fixture housings (110, 120) are threaded and attached to a universal support (102a) of connector (102), each one of which is configured for carrying and deploying a different type of bird-repellent (e.g., bird-repellent (10)) with a different type of wire-attachment mechanism (e.g., mechanism (11)). Furthermore, each fixture housing (110, 120) comprises one or more unique leading-rods (111, 121) that are designed to guide the wire being approached by device (100) towards deployment of a desired type of bird-repellent (e.g., bird-repellent (10)) thereon.

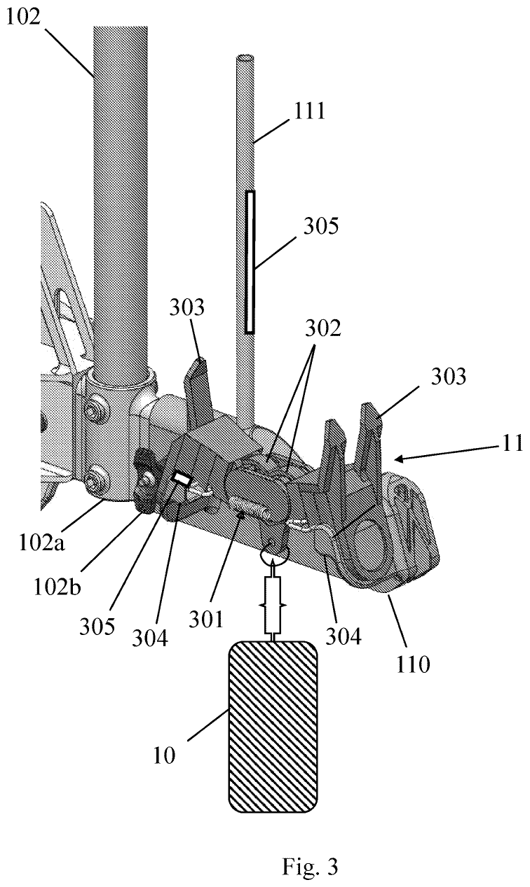

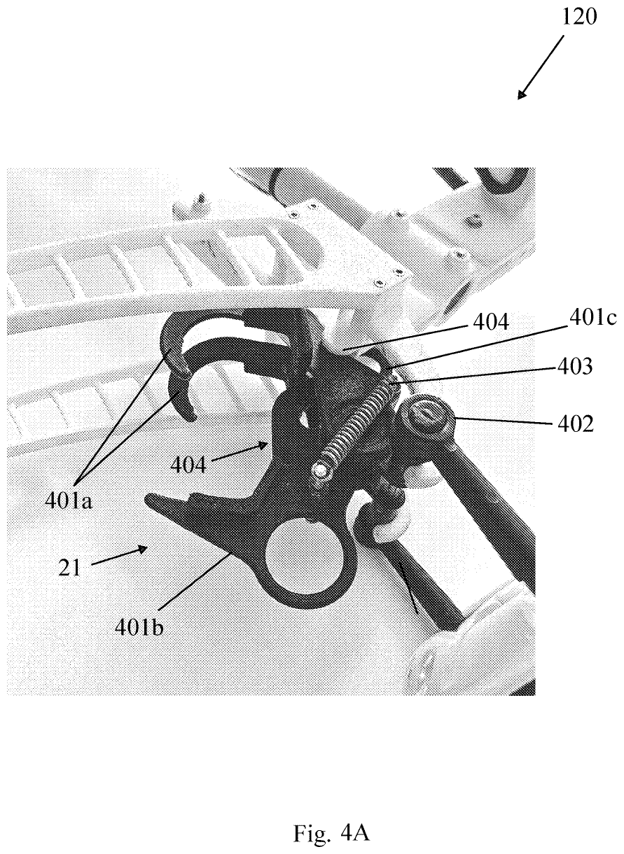

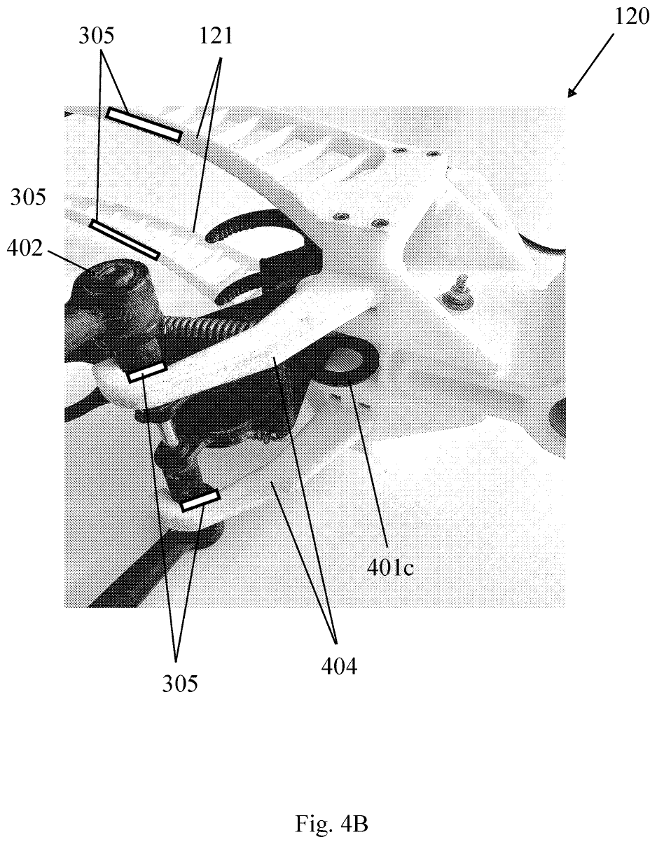

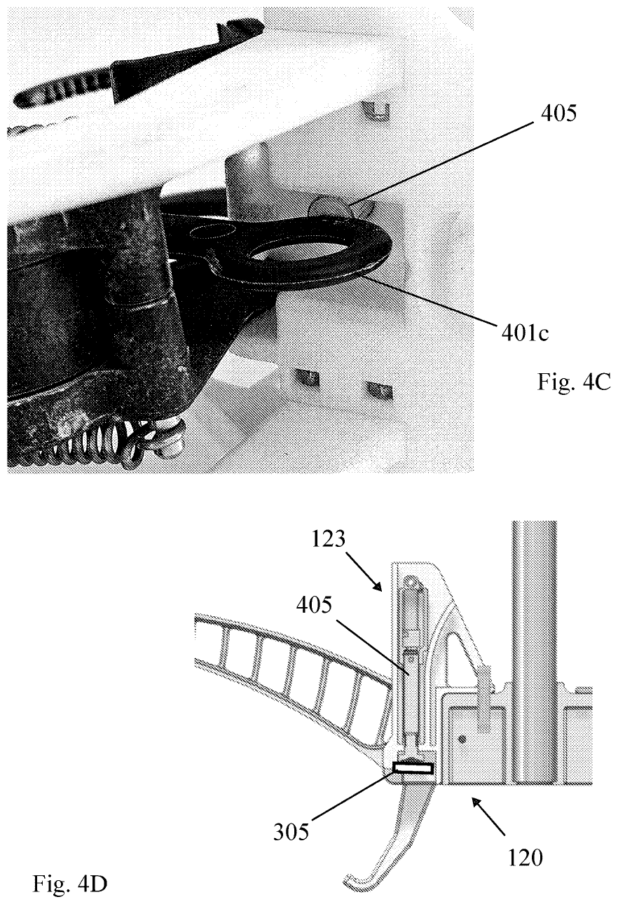

For instance, a UAV carrying device (100) may initially approach a target deployment position along a wire, until one or more unique leading-rods (111, 121), of a fixture housing (110,120) associated with a desired unit of a bird-repellent or IoT devices, contacts said wire, and keep approaching the wire while leading-rods (111, 121) guides the wire towards a corresponding wire-attachment mechanism (11, 21). Whereas the wire is substantially confined by the wire-attachment mechanism (11, 21), the latter interlocks and attaches to the wire (as further explained with respect to FIGS. 3 and 4).

As explained herein above, device (100) may comprise different types of leading-rods (111, 121): each one is suited for a different type of bird-repellent or IoT device based on the design of the corresponding wire-attachment mechanism, such as illustrated by FIGS. 2A and 2B, where a first leading-rod (111) is configured to provide guided sliding of the approached overhead wire towards wire-attachment mechanism (11), where wire-attachment mechanism (11) is configured, and correspondingly positioned on fixture housing (110), to clamp the wire from below. Therefore, a UAV carrying device (100) initially approaches the wire laterally, with fixture housing (110) vertically located below the wire and when the wire contacts leading-rod (111), the UAV elevates and the wire slides downwardly towards wire-attachment device (11). Further in the embodiment of FIG. 2B, a second leading-rod (121) is configured to provide guided sliding of the approached overhead wire towards wire-attachment mechanism (21), where wire-attachment mechanism (21) is configured, and correspondingly positioned on fixture housing (120), to clamp the wire from aside. Therefore, a UAV carrying device (100) initially approaches the wire downwardly, with fixture housing (120) located aside from the wire and when the wire contacts leading-rods (121), the UAV shifts aside and the wire slides laterally towards wire-attachment device (21).

Notably, as illustrated in FIGS. 2A and 2B, the shape and design of leading-rods (111,121) may vary suitably for different applications of the proposed deployment device (100), for example, as leading-rod (111) may also connect to the extension connector (102), e.g., to provide increased stability thereof in certain cases. Further shown in FIGS. 2A and 2B are fasteners 102b that are utilized for affixing various interchangeable fixture housings, such as housings (110, 120) to the universal support (102a) of connector (102).

Further illustrated in FIG. 2A is an image-capturing device, such as a camera (103) that can provide images and/or video stream of the wire section approached by a UAV carrying device (100), other means such as a proximity sensor, a metal indicator, or a current indicator (not shown) may also provide an indication (e.g., on the UAV remote controller) that leading-rod (111, 121) has touched the wire, so that the autonomous control of the UAV, or the UAV operator may slow down the UAV approach speed and relieve redundant loading off the overhead wire.

The wire-attachment interlocking on the overhead wire may be triggered by passive means, such as described in detail in FIG. 3, or by active means, such as an electric actuator (123) such as described in detail in FIGS. 4A-4D. The actuator may be of any suitable type according to the design and characteristics of its wire-attachment mechanism (11, 21) and be fed by a suitable power supply and corresponding wiring (201). Of course, alternative actuators may be selected by one skilled in the art in accordance with specific applications of the proposed deployment device (100).

Now referring to FIG. 3, which further illustrates fixture housing (110) and the interlocking of wire-attachment mechanism (11) carried thereby and supported at a spring-loaded open state by supports (304), according to an embodiment of the present invention. Wire-attachment mechanism (11) comprises a spring (301), a spring-release mechanism such as a tripping latch (302), and two grasping arms (303). When said spring-release mechanism (302) is pressed against a wire, spring (301) is released and forces grasping arms (303) to snap together and clamp the wire in between. Grasping arms (303) interlock together and prevent movement of the bird-repellent (10) along the wire as well as its unintentional release therefrom. Fixture housing (110) and supports (304) are specifically designed to grasp wire-attachment mechanism (11) firmly in its spring-loaded open state and to allow its uninterrupted release therefrom when grasping arms (303) clamp the overhead wire.

Further illustrated in FIG. 3 is a load cell (305) attached to supports (304) and to leading-rod (111). Load cells (305) (e.g., piezo-electric based pressure sensors, IR/LASER presence sensors and any other suitable sensors) may provide an indication as to the interlocking of wire-attachment mechanism (11) by sensing pressure relief on supports (304) (i.e. whereas grasping arms (303) snap together and thus are not held on supports (304)); and may provide a contact indication as leading-rod (111) contacts the wire. Such indication may enable, for instance, the UAV (autonomously), or its operator, to begin distancing the UAV from the overhead wire following deployment of a bird-repellent, or to reduce the UAV flight speed as leading-rod (111) contacts the wire, and thereby, to avoid redundant loading of the overhead wire.

FIGS. 4A-4D show enlarged views of fixture housing (120) and further illustrate the interlocking of wire-attachment mechanism (21) carried thereby and supported at a spring-loaded open state by supports (404), according to an embodiment of the present invention. Wire-attachment mechanism (21) comprises top and bottom grasping arms (401a) and (401b) rotatably connected by a hinge (402) and further connected by a spring (403), where at a certain angle between the top and bottom grasping arms (401a) and (401b) spring (403) is at its most-extended state (to be referred hereinafter as the “no-return angle” for the sake of simplicity). Grasping arms (401a, 401b) may be actuated to pass the no-return angle towards either of the closed/open states of wire-attachment mechanism (21), resulting in retraction of spring (403), which exerts a significant clamping/opening of wire-attachment mechanism (21). The geometry of wire-attachment mechanism (21) forces its firm grasp by supports (404) at its spring-loaded open state, and its uninterrupted release therefrom when grasping arms (401a, 401b) clamp the overhead wire.

The interlocking of wire-attachment mechanism (21) is actuated by a piston (405) of electric actuator (123) that pushes a release arm (401c) which extends from bottom grasping arm (401b), thereby rotating bottom grasping arm (401b) to pass the no-return angle towards a clamped state of wire-attachment mechanism (21).

Further illustrated in FIGS. 4B and 4D are load cells (305) attached to supports (404) to leading-rod (111) and to piston (305). Load cells (305) may provide an indication as to the interlocking of wire-attachment mechanism (21) thus its release from supports (404); an actuation indication as piston (405) pushes release arm (401c) to initiate the snapping of grasping arms (401a, 401b) (i.e., thus its clamping of the overhead wire; and may also provide a contact indication as leading-rods (121) contacts the wire. Such indication may enable, for instance, the UAV (autonomously), or its operator, to begin distancing the UAV from the overhead wire following deployment of a bird-repellent, or to reduce the UAV flight speed as leading-rod (121) contacts the wire, and thereby, to avoid redundant loading of the overhead wire.

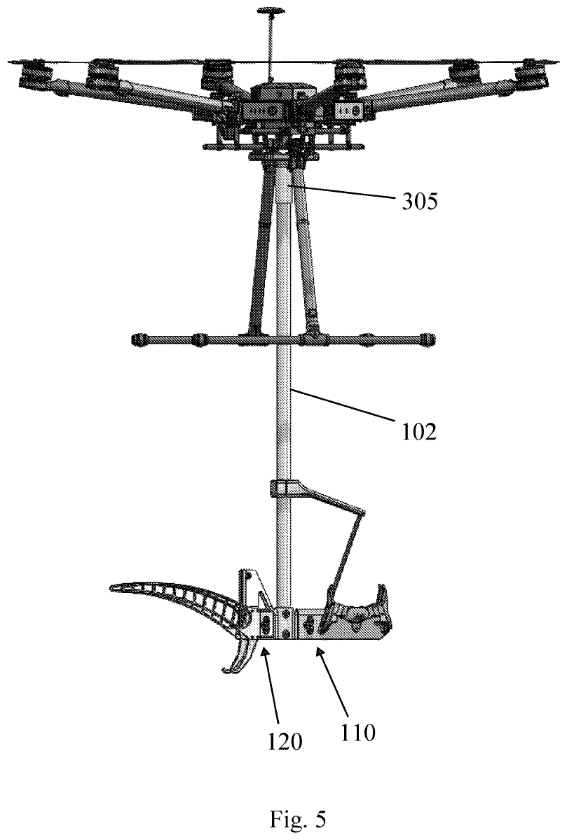

FIG. 5 illustrates an exemplary configuration of a UAV that carries device (100), wherein connector (102) is at an extended state, and where a contact sensor (305) is installed at the mounting of connector (102) to the UAV, so as to provide an indication as to the engagement of any of leading-rods (111, 121) of device (100) with an overhead wire.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

In an example, device (100) comprises: a) one or more interchangeable fixture housings (110, 120), each of which is adapted to hold and facilitate the deployment of a different type of wire-attachment mechanism, integrated with a bird-repellents or an IoT device, wherein each of the one or more interchangeable fixture housings (110, 120) comprises one or more unique leading-rod (111,121), and b) an optionally insulated and rigid/extendible extension connector (102) configured to connect with a carrying unmanned aerial vehicle (UAV), wherein extension connector (102) is adapted with universal support (102a) configured to receive one or more units of said one or more interchangeable fixture housings (110, 120), and thus, one or more wire-attachment mechanisms of different types, thereby facilitating the deployment of one or more units of the bird-repellent or IoT devices, by a single UAV, and wherein device (100) further comprises one or more sensors that indicate as to the engagement of said device with a wire.

In another example, the multipurpose deployment device (100) according to any of the above embodiments, further comprises an image-capturing device (103).

In a third example device (100) comprises a first and a second interchangeable fixture housings (110, 120), wherein each one of said first and second interchangeable fixture housings (110, 120) comprises a unique leading-rod (111, 121) and is designed to carry and deploy a bird-repellent or IoT device having a different wire-attachment mechanism.

It should be noted that interchangeable fixture housings (110, 120) according to any of the embodiments above, may be integrated with similar or with different bird-repellents/IoT devices. It should be further noted that in either of the above embodiments and examples of device (100), the latter may or may not comprise an image-capturing device, and/or Global Positioning System (GPS).

In another aspect, a method for deploying bird-repellent or IoT (Internet of Things) devices with different types of wire-attachment mechanisms onto a wire is disclosed, the method comprising the steps of: a) providing a multipurpose deployment device (100) according to any of the above embodiments and examples and connecting the same by an extension connector (102) to an unmanned aerial vehicle (UAV), b) attaching one or more wire-attachment mechanisms of different types, integrated with bird-repellent or IoT device(s), to one or more adequate interchangeable fixture housings (110, 120), and attaching the same to universal support (102a) of said extension connector (102), c) approaching a target deployment position along a wire with said UAV until a leading-rods (111, 121), of an interchangeable fixture housing (110, 120) associated with a desired unit of the various bird-repellent or IoT devices, contacts said wire, and keep approaching the wire while said one or more unique leading-rods (111, 121) guide the wire towards the corresponding wire-attachment mechanism carried on the associated interchangeable fixture housing (110, 120), d) interlocking the wire-attachment mechanism onto the wire thereby attaching said desired unit of the various bird-repellent or IoT devices onto the wire, e) repeating steps (c) and (d) until all bird-repellent or IoT devices of step (b) are deployed at their target deployment positions along the wire, f) distancing the UAV from said wire; and repeating steps (b) through (f) as needed until all required bird-repellent or IoT devices are mounted and secured on the wire.

The above method may be applied for deploying any desired device, suitable for carriage and deployment as described in the above embodiments and examples, on a live electric wire, or any other wire. Furthermore, device (100) according to any of the above embodiments and examples may utilize a GPS system for deploying bird-repellents and/or IoT devices at desired target deployment positions along a wire, wherein the interlocking of the wire-attachment mechanism in step (d) above may be carried out automatically by pressing said wire-attachment mechanism against the wire, or by activation of an actuator (123) and/or via an electrical activation of said wire-attachment mechanism.

1-30. (canceled)

31. A multipurpose deployment device for deploying bird-repellent or Internet of Things (IoT) devices with different types of wire-attachment mechanisms onto a wire, said device comprises:
a) one or more interchangeable fixture housings, each of which is adapted to hold and facilitate the deployment of a different type of wire-attachment mechanism, integrated with a bird-repellents or an IoT device, wherein each of said one or more interchangeable fixture housings comprises one or more unique leading-rod; and
b) an extension connector configured to connect with a carrying Unmanned Aerial Vehicle (UAV),
wherein said extension connector is adapted with universal support configured to receive one or more units of said one or more interchangeable fixture housings, and thus, one or more wire-attachment mechanisms of different types, thereby facilitating the deployment of one or more units of said bird-repellent or IoT devices, by a single UAV.

32. The deployment device of claim 31, wherein the wire-attachment mechanism comprises one or more sensors that indicate the engagement state of said wire-attachment mechanism with a wire.

33. The multipurpose deployment device of claim 31, wherein the extension connector is insulated.

34. The multipurpose deployment device of claim 33, wherein the insulated extension connector is a fixed rigid pole.

35. The multipurpose deployment device of claim 33, wherein said insulated extension connector is extendable.

36. The multipurpose deployment device of claim 31, further comprising an image-capturing device.

37. The multipurpose deployment device of claim 31, wherein said device comprises two interchangeable fixture housings of preselected types.

38. An Unmanned Aerial Vehicle (UAV) equipped with the multipurpose deployment device of claim 31.

39. The UAV of claim 38, further comprising an image-capturing device.

40. The UAV of claim 38, further comprising a positioning system.

41. A method for deploying bird-repellent or IoT devices with different types of wire-attachment mechanisms onto a wire, the method comprising the steps of:
a) providing a multipurpose deployment device that comprises:
i. one or more interchangeable fixture housings, each of which is adapted to hold and facilitate the deployment of a different type of wire-attachment mechanism, integrated with a bird-repellents or an IoT device, wherein each of said one or more interchangeable fixture housings comprises one or more unique leading-rod; and
ii. an extension connector configured to connect with a carrying UAV, wherein said extension connector is adapted with universal support configured to receive one or more units of said one or more interchangeable fixture housings, and thus, one or more wire-attachment mechanisms of different types,
b) attaching one or more wire-attachment mechanisms of different types, integrated with bird-repellent or IoT device(s), to one or more adequate interchangeable fixture housings, and attaching the same to universal support of said extension connector;
c) approaching a target deployment position along a wire with said UAV until a leading-rods, of an interchangeable fixture housing associated with a desired unit of said various bird-repellent or IoT devices, contacts said wire, and keep approaching the wire while said one or more unique leading-rods guide said wire towards the corresponding wire-attachment mechanism carried on said associated interchangeable fixture housing;
d) interlocking said wire-attachment mechanism onto said wire thereby attaching said desired unit of said various bird-repellent or IoT devices onto said wire;
e) repeating steps (c) and (d) until all said bird-repellent or IoT devices of step (b) are deployed at their target deployment positions along said wire;
f) distancing said UAV from said wire; and
g repeating steps (b) through (f) as needed until all required bird-repellent or IoT devices are mounted and secured on said wire.

42. The method of claim 41, wherein said wire is a live electric wire.

43. The method of claim 41, for mounting and securing multiple IoT devices onto an electric wire.

44. The method of claim 41, wherein steps (b) of attaching one or more wire-attachment mechanisms of different types, integrated with bird-repellent or IoT device(s), to one or more adequate interchangeable fixture housings, and attaching the same to universal support of said extension connector, is carried out manually or automatically using a dedicated dispenser.

45. The method of any one of claim 41, wherein the approaching a target deployment position along a wire with said UAV in step (c) is carried out using a positioning system that determines the position and distance of the UAV relative to a previously mounted bird-repellent or IoT device.

46. The method of claim 41, wherein the interlocking of said wire-attachment mechanism in step (d) is carried out automatically by pressing said wire-attachment mechanism against a wire.

47. The method of claim 11, wherein the interlocking of said wire-attachment mechanism in step (d) is carried out automatically by activation of an actuator or via an electrical activation of said wire-attachment mechanism.

48. The multipurpose deployment device of claim 31, wherein said device is configured to carry a single interchangeable fixture housings of preselected type facilitating the anchoring of preselected bird-repellent or IoT device units of various types by a single UAV.
